(19) United States
(12) Patent Application Publication
(10) Pub. No.: US 2006/0256261 A1
(43) Pub. Date: Nov. 16, 2006

(54) Optical system design

(76) Inventors: Kuan-Hsu Fan Chiang, Hsinchu City (TW); Xinyu Zhu, Orlando, FL (US); Shin-Tson Wu, Orlando, FL (US); Shu-Hsia Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/196,350

(22) Filed: Aug. 4, 2005

(30) Foreign Application Priority Data
May 10, 2005 (TW) 094115146

(51) Int. Cl. G02F 1/1335

(52) U.S. Cl. 349/98; 349/5

(57) ABSTRACT

This invention discloses an optical system design, which is used in a liquid crystal display apparatus. The optical system design at least comprises a light generation module, a circular polarization module and a liquid crystal light valve, wherein the light generation module is used to generate a light, the circular polarization module is used to modulate the polarization state of the light to a circular polarization state, and the liquid crystal light valve is used to modulate the polarization state of the light, so as to modulate the intensity of the light to show the image. The optical system design is able to solve the problem of fringing-field effects.

### FIELD OF THE INVENTION

The present invention relates to an optical system design for liquid crystal display apparatus which, in particular, includes a circular polarization module.

### BACKGROUND OF THE INVENTION

The applications of liquid crystal display (LCD) apparatus are now in widespread use. For example, it has been equipped with LCD TV, mobile phone, personal digital assistant (PDA), digital camera and display panels on automobile, etc.

The design of optical systems determines the display quality of an LCD apparatus. It is used to produce images with good contrast ratio, improve the efficiency of light and accelerate the response time to display images in order to have clear images, brilliant brightness and avoidance of remaining images. There are a variety of optical systems that utilize Twisted Nematic (TN) LCD design, Super Twisted Nematic (STN) LCD design, In-Plane Switch (IPS) LCD design, Optical Compensated Birefringence (OCB) LCD design and Vertical Alignment (VA) LCD design etc. The design of these prior art systems is to modulate a light source with a non-linear polarization mode to become a light source with a linear polarization mode, pass this light source through a liquid crystal light valve which is used to modulate the polarization status of through light and then the light with different brightness can be obtained to produce images by modifying the polarization status of this light. Each specific polarization status corresponds to a specific level of brightness.

The TN LCD and STN LCD technologies suffer from the narrow viewing angle so that the use of TN LCD and STN LCD is limited in the low end products. IPS LCD and OCB LCD are not used widely due to complex and difficult manufacturing processes although IPS LCD and OCB LCD can be used to conquer the narrow viewing angle problem. As a result of these shortcomings, the VA LCD is becoming the mainstream of the LCD optical system design. There are many technologies, like Multi-domain Vertical Alignment (MVA) LCD, which are developed based on the VA LCD design. The design principle is the same between MVA LCD and VA LCD basically. A VA LCD design is used as an example to introduce those prior art systems.

FIG. 1 illustrates the nature of the polarization status of light. The light beam 11, which can be called as an electromagnetic wave or a light, propagates along Z-axis and, therefore, creates oscillations of the electric field and magnetic field on the XY plane perpendicular to Z-axis. The polarization status of the light beam 11 is defined as the oscillation status of the specific electric and magnetic field. Take the oscillation of electric field as an example. The oscillation direction of electric field 111 of light beam 11 parallel to X-axis and the amplitude of electric field 111 changes as time varies. Viewing electric field from XY plane, it can be found that the trajectory of the electric field is not only parallel but also back and forth on the X-axis. The polarization status of the light beam 11 is defined as a linear polarization status. By the law of identity to the light beam 12, the oscillation direction of the electric field 121 of the light beam 12 is parallel to Y-axis and the amplitude of the electric field 121 changes as time varying. Viewing the electric field from XY plane, it can be found that the trajectory of the electric field is not only parallel to but also back and forth on the Y-axis. We call the polarization status of the light beam 12 as a linear polarization status. Any kinds of the polarization status, like the circular or elliptical polarization status, can be composed of these two independent linear polarization elements which are the light beam 11 and the light beam 12.

FIG. 2 illustrates the polarization status of light on the XY plane. The trajectory of the direction of the electric field oscillation 111 is back and forth along the X-axis as a straight line. The polarization status of the light beam 11 is called as a linear polarization status and the corresponding Jones Matrix is

$$( \begin{matrix}1 \\ 0\end{matrix} ) .$$

Jones Matrix is a mathematic method that used to calculate the polarization status of light. The polarization status of the light beam 12 is also called a as linear polarization status and the corresponding Jones Matrix is

$$( \begin{matrix}0 \\ 1\end{matrix} ) .$$

The trajectory of the direction of the electric field oscillation 211 of the light beam 21 is a circle on the XY plane. We call the polarization status of the light beam 21 as a circular polarization status and the corresponding Jones matrix is

$$( \begin{matrix}1 \\ i\end{matrix} ) ,$$

in particular, it is also called as a clockwise circular polarization status because the trajectory of the direction of the electric field oscillation 211 is clockwise. The trajectory of the direction of the electric field oscillation 221 of the light beam 22 forms an ellipse on the XY plane. We call the polarization status of the light beam 22 as an elliptic polarization status and the corresponding Jones matrix is

$$( \begin{matrix}1 \\ 2 i\end{matrix} ) .$$

FIG. 3 illustrates a prior art optical system design, at least comprises a light generation module 31, a polarizer 32, a liquid crystal light valve 33 and an analyzer 34. The optical system design is called a vertical alignment LCD design if the type of liquid crystal light valve 33 is a vertical alignment liquid crystal. In the example introduced in FIG. 3, the liquid crystal light valve 33 is a transparent liquid crystal light valve so that the optical system in FIG. 3 is a transparent VA LCD system. The light generation module 31, which is used to produce a light beam 311, can be a light source module of a projector or a back-lighted source module. The polarizer 32 and analyzer 34 are both linear polarization components and used to modulate the polarization status of the light beam 311 to become a linear polarization status. The angle between transparent axis 321 of the polarizer 32 and X-axis is 45°. The Jones matrix of the polarizer 32 is

$$( \begin{matrix}\frac{1}{2} & \frac{1}{2} \\ \frac{1}{2} & \frac{1}{2}\end{matrix} )$$

and that angle between the transparent axis 341 of the analyzer 34 and X-axis is −45°. The Jones matrix of the analyzer 34 is

$$( \begin{matrix}1 \\ 1\end{matrix} )$$

The Jones matrix of the light beam 311 is

$$( \begin{matrix}\frac{1}{2} & - \frac{1}{2} \\ - \frac{1}{2} & \frac{1}{2}\end{matrix} ) .$$

after it passes through the polarizer 32. The principle for the liquid crystal light valve 33 to modulate the polarization status of the light beam 311 is to apply different voltages on the liquid crystal light valve 33 to change the arrangement of the liquid crystal molecules inside the liquid crystal light valve 33. It causes the corresponding phase lag of the light beam 311 after the light beam 311 passes liquid crystal light valve 33. The polarization status changes as the phase lag is modified. The Jones matrix of the liquid crystal light valve 33 is

$$( \begin{matrix}{ⅇ}^{- ⅈ \frac{Γ}{2}} & 0 \\ 0 & {ⅇ}^{ⅈ \frac{Γ}{2}}\end{matrix} )$$

where Γ is the phase lag. In a word, the Jones matrix of the polarization status of the light beam 311 after passing the analyzer 34 is

$$( \begin{matrix}\frac{1}{2} & - \frac{1}{2} \\ - \frac{1}{2} & \frac{1}{2}\end{matrix} ) \cdot ( \begin{matrix}{ⅇ}^{- ⅈ \frac{Γ}{2}} & 0 \\ 0 & {ⅇ}^{- ⅈ \frac{Γ}{2}}\end{matrix} ) \cdot ( \begin{matrix}1 \\ 1\end{matrix} ) = \frac{1}{2} ( {ⅇ}^{- ⅈ \frac{Γ}{2}} - {ⅇ}^{ⅈ \frac{Γ}{2}} ) ( \begin{matrix}1 \\ - 1\end{matrix} )$$

and the brightness of the light beam 311 is

$$2 \cdot {sin}^{2} ( \frac{Γ}{2} ) .$$

It is that we can get different brightness by applying different voltage which changes the phase lag.

FIG. 4 illustrates the relationship between brightness and phase lag. The vertical coordinates represent the light intensity whose unit is arbitrary unit and is usually expressed by percent (%). The abscissa represents the phase lag Γ whose unit is radian (rad.) and different phase lag can be obtained by applying different electrical voltage. The curve 41 is the corresponding relationship between the light intensity and the phase lag. The dotted line 42 shows that different light intensity corresponds to different phase lag. There are usually a plural number of pixels that arranged as an array on LCD apparatus. The formation of images is to have different brightness on each pixel by applying specific electric voltages on the liquid crystal light valve of specific pixels. We apply different voltages on the liquid crystal light valve of each pixel to have different brightness of light beams. There is a fringing-field effect which causes distortion of the brightness of the light beam due to a horizontal electric field created along the fringe of neighboring pixels. The electric field produced due to the different voltages applied on the liquid crystal light valve of different pixels affects the arrangement of the liquid crystal molecules, and then causes the phase lag of the light beam passed through the liquid crystal light valve and furthermore, distorts the brightness of the light beam. The liquid crystal molecules will be deviated from the ideal orientation by a deflection angle θ when the fringing-field exceeds a threshold value. Considering the deflection angle θ due to fringing-field effect, the Jones matrix of the polarization status of the light beam 311 passed through analyzer 34 is

$$( \begin{matrix}\frac{1}{2} & - \frac{1}{2} \\ - \frac{1}{2} & \frac{1}{2}\end{matrix} ) \cdot ( \begin{matrix}cos θ & - sin θ \\ sin θ & cos θ\end{matrix} ) \cdot ( \begin{matrix}{ⅇ}^{- ⅈ \frac{Γ}{2}} & 0 \\ 0 & {ⅇ}^{ⅈ \frac{Γ}{2}}\end{matrix} ) \cdot ( \begin{matrix}cos θ & sin θ \\ - sin θ & cos θ\end{matrix} ) \cdot ( \begin{matrix}1 \\ 1\end{matrix} ) = - i cos ( 2 θ ) sin ( \frac{Γ}{2} ) ( \begin{matrix}1 \\ - 1\end{matrix} )$$

where

$$( \begin{matrix}cos θ & - sin θ \\ sin θ & cos θ\end{matrix} ) \cdot ( \begin{matrix}{ⅇ}^{ⅈ \frac{Γ}{2}} & 0 \\ 0 & {ⅇ}^{ⅈ \frac{Γ}{2}}\end{matrix} ) \cdot ( \begin{matrix}cos θ & sin θ \\ - sin θ & cos θ\end{matrix} )$$

is the Jones matrix of liquid crystal light valve 33 with considering the effect of the deflection angle θ. The brightness corresponds to the light beam 311 is

$$2 \cdot {cos}^{2} ( 2 θ ) \cdot {sin}^{2} ( \frac{Γ}{2} )$$

which means different brightness can be obtained due to different phase lag Γ by changing the electric voltage.

FIG. 5 illustrates the corresponding relationship between brightness and deflection angle wherein the phase lag is an arbitrary specific value. The vertical coordinates represent the light intensity whose unit is arbitrary unit and is usually expressed by percent (%) which shows the brightness under the fringing-field effect. The abscissa represents the deflection angle θ whose unit is degree. The deflection angle θ is determined by the amplitude of the electric field due to the fringing-field effect. The curve 51 is the corresponding relationship between light intensity and deflection angle. The dotted line 52 shows the light intensity is decreased to 88% with deflection angle 10° and dotted line 53 decreased to 75% with deflection angle 15° which causes one forth deterioration compared to the original brightness. The fringing-field effect is the main factor to downgrade the display quality of the LCD apparatus. It decreases the contrast ratio, defers the dynamic response of the image, increases the response time and results in residue image phenomenon. Due to the pressing demand on the high resolution LCD apparatus, it is required to increase more pixels on the original panel. This makes the inter-pixel gap smaller and smaller and results in severe fringing-field effect and comfortless display quality.

The prior art system can not overcome the emerging fringing-field effect which downgrades the display quality of the LCD apparatus. We present an invention which can solve the problem from the fringing-field effect by using an optical system design with circular polarization module.

### SUMMARY OF THE INVENTION

The optical system design at least comprises a light generation module, a circular polarization module and a liquid crystal light valve. The light generation module is used to produce a light beam. The circular polarization module is used to modulate the polarization status of the light beam to be in a circular polarization status. The liquid crystal light valve is used to modulate the polarization status of the light beam so as to have different light intensity and form images.

In the prior art system, the light beam with the linear polarization status is used. In this condition, the distortion of the liquid crystal molecular caused by fringing-field effects will deteriorate the image quality of the display severely. In the present invention, the light beam with symmetric property of the circular polarization status does not interfere with the arrangement of the liquid crystal molecules. Therefore, expected light intensity can be obtained for the liquid crystal display illuminated by the circularly polarized light.

The present invention provides an optical system design with the circular polarization module. Modulating the polarization status of the light beam by the circular polarization module can solve the fringing-field effect so that the display quality of the LCD apparatus is improved obviously.

### BRIEF DESCRIPTION OF THE DRAWINGS

Preferred embodiments of the present invention will now be described, by way of example only, with reference to the accompanying drawings in which:

FIG. 1 illustrates the nature of the polarization status of light;

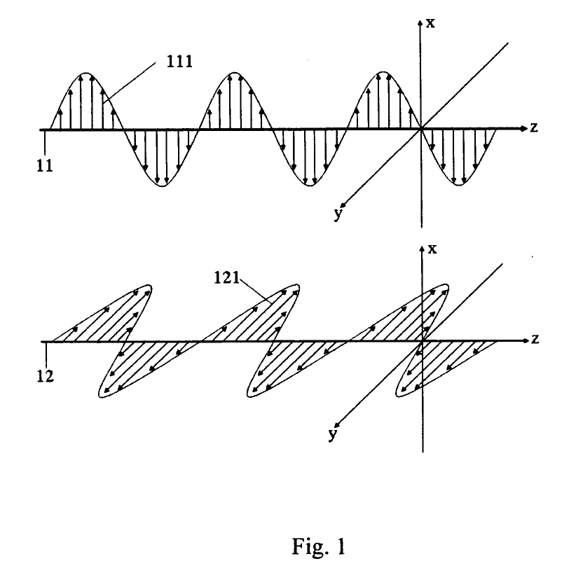

FIG. 2 illustrates the polarization status of light on the XY plane according to a different polarization status which means different Jones matrix;

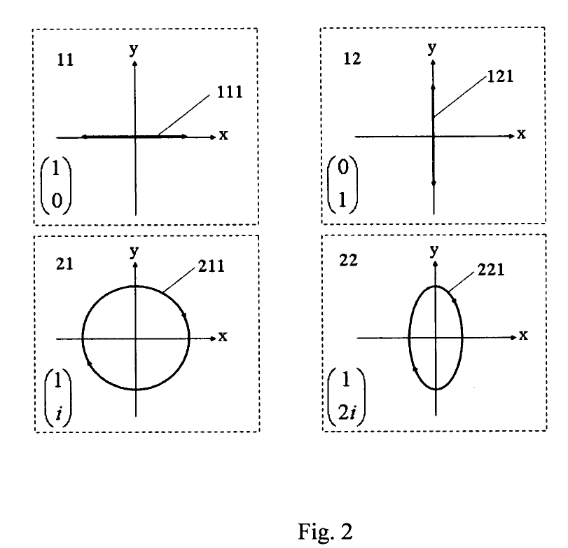

FIG. 3 illustrates a prior art optical system design;

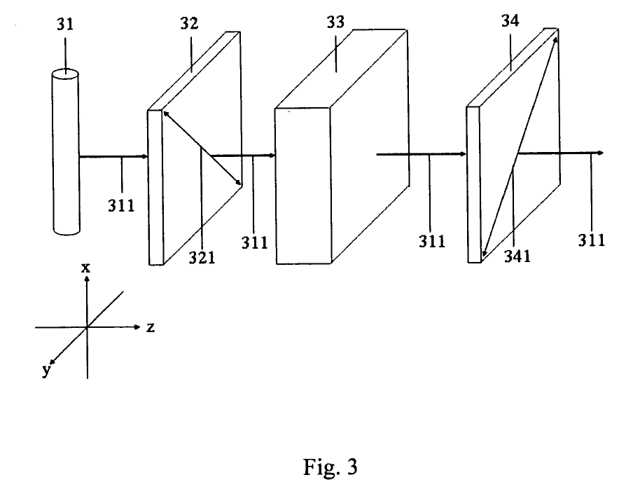

FIG. 4 illustrates the relationship between brightness and phase lag according to the prior art optical system design;

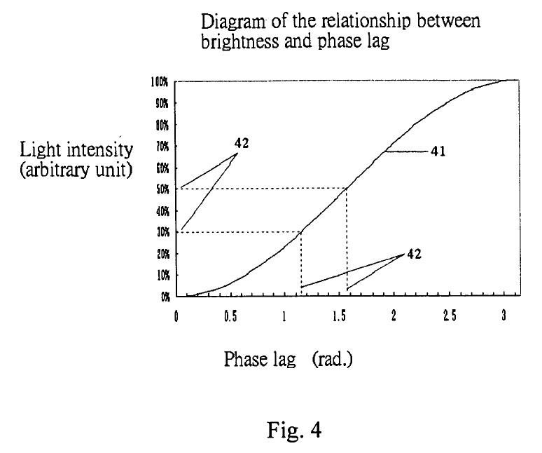

FIG. 5 illustrates the corresponding relationship between brightness and deflection angle wherein the phase lag is an arbitrary specific value according to the prior art optical system design;

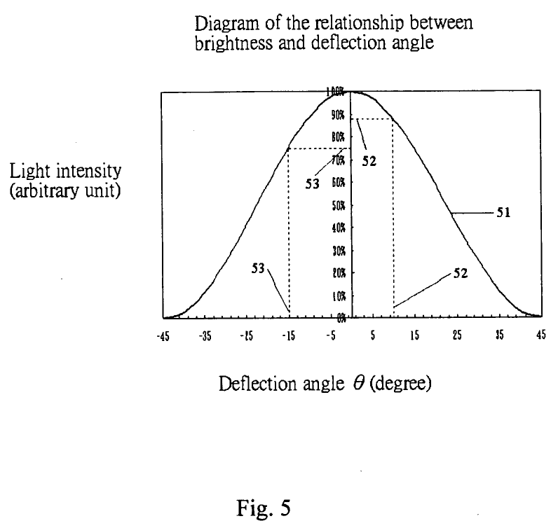

FIG. 6 is an optical system design according to the present invention;

FIG. 7 is a dissection diagram of the polarization module and the analyzer module according to the FIG. 6;

FIG. 8 illustrates the relationship between brightness and phase lag according to the apparatus in FIG. 7;

FIG. 9 is a dissection diagram illustrates another combination of the circular polarization module and analyzer module in FIG. 6;

FIG. 10 illustrates another optical system implemented based on the present invention; and

FIG. 11 illustrates an application diagram of an optical system design according to the present invention.

### DETAILED DESCRIPTION OF THE PREFERRED EMBODIMENTS

To make it easier for our examiner to understand the objective of the invention, its innovative features and performance, a detailed description and technical characteristics of the present invention are described together with the drawings as follows.

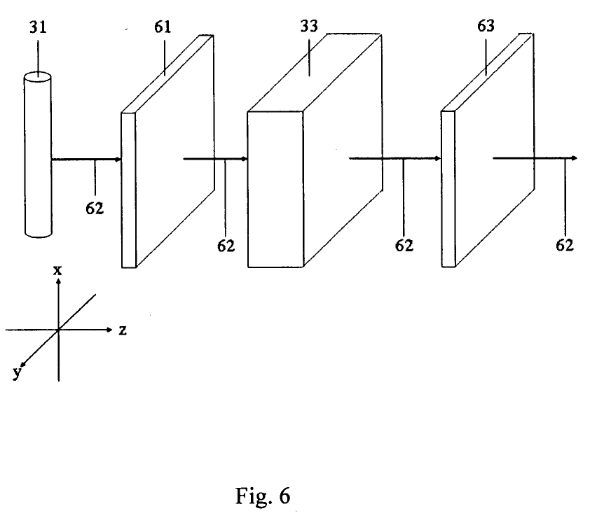

Referring to FIG. 6, it is an optical system design according to the present invention. The optical system design comprises a light generation module 31, a circular polarization module 61 and a liquid crystal light valve 33. The liquid crystal light valve 33 can be a vertical alignment liquid crystal light valve, in particularly, negative vertical alignment liquid crystal light valve. In this embodiment, the liquid crystal light valve 33 is a transparent liquid crystal light valve and then this optical system design is a transparent liquid crystal system design. The light generation module 31 which is used to generate a light beam 62 can be a light source module of a projector or a back-lighted module. The present invention can be used in the LCD apparatus of projectors if the light generation module 31 is a light source module of a projection system or for the LCD apparatus of computers if the light generation module 31 is a back-lighted module. The circular polarization module 61 is used to modulate the polarization status of the light beam 62 to be in a circular polarization status. The liquid crystal light valve 33 is used to modulate the polarization status of the light beam 62, especially related to the brightness of the light beam 62. Besides, an analyzer module 63 can be added additionally in this optical system design to determine the light intensity corresponding to a specific polarization status.

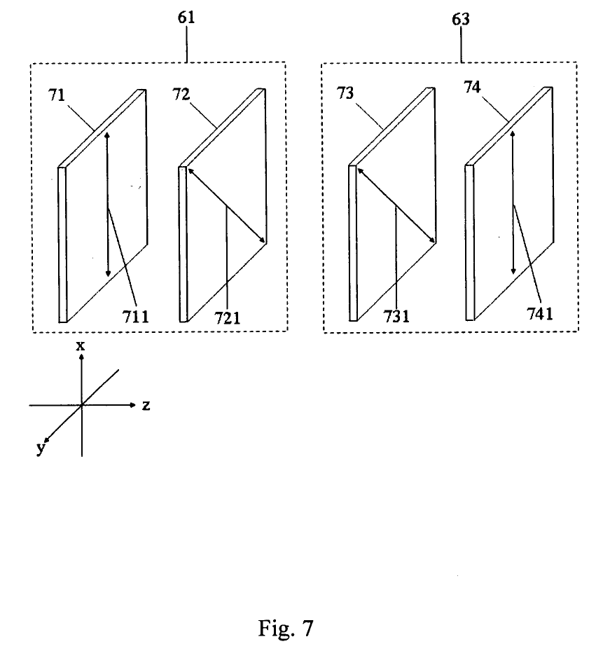

FIG. 7 is a dissection diagram of the polarization module and the analyzer module according to the FIG. 6. The circular polarization module 61 is composed of a linear polarization component 71 and a quarter wave plate 72. The Jones matrix of the linear polarization module 71 is

$$( \begin{matrix}1 & 0 \\ 0 & 0\end{matrix} )$$

because the orientation of the transparent axis 711 of the linear polarization component 71 is the same as that of the X-axis. The Jones matrix of the polarization status of the light beam 62 passes through the linear polarization component 71 is

$$( \begin{matrix}1 \\ 0\end{matrix} ) .$$

The included angle between the slow axis of the quarter wave plate 72 and the transparent axis 711 of the linear polarization component 71 is 45° and the corresponding Jones matrix is

$$( \begin{matrix}cos ( \frac{π}{4} ) & - i \cdot sin ( \frac{π}{ 4} ) \\ - i \cdot sin ( \frac{π}{4} ) & cos ( \frac{π}{4} )\end{matrix} ) .$$

The Jones matrix of the polarization status of the light beam 62 after it passes through the circular polarization module is

$$( \begin{matrix}cos ( \frac{π}{4} ) & - i \cdot sin ( \frac{π}{ 4} ) \\ - i \cdot sin ( \frac{π}{4} ) & cos ( \frac{π}{4} )\end{matrix} ) \cdot ( \begin{matrix}1 \\ 0\end{matrix} ) = \frac{1}{\sqrt{2}} ( \begin{matrix}1 \\ - i\end{matrix} )$$

which represents a circular polarization status. Actually, it is a counterclockwise circular polarization status. The analyzer 63 is comprised of a quarter wave plate 73 and a linear polarization component 74. The direction of the slow axis 731 of the quarter wave plate 73 is parallel to the slow axis 721 of the quarter wave plate 72 and the corresponding Jones matrix is

$$( \begin{matrix}cos ( \frac{π}{4} ) & - i \cdot sin ( \frac{π}{ 4} ) \\ - i \cdot sin ( \frac{π}{4} ) & cos ( \frac{π}{4} )\end{matrix} ) .$$

The direction of the transparent axis 741 of the linear polarization component 74 is parallel to the transparent axis 71 of the linear polarization component 71 and the corresponding Jones matrix is

$$( \begin{matrix}1 & 0 \\ 0 & 0\end{matrix} ) .$$

The corresponding Jones matrix of the liquid crystal light valve 33 is

$$( \begin{matrix}{ⅇ}^{- ⅈ \frac{Γ}{2}} & 0 \\ 0 & {ⅇ}^{ⅈ \frac{Γ}{2}}\end{matrix} )$$

where Γ represents the phase lag. The theory to modulate the polarization status of the light beam 62 by liquid crystal light valve 33 is to apply a specific electric voltage on the liquid crystal light valve 33. The electric voltage changes the arrangement of the liquid crystal molecules in liquid crystal light valve 33. The change of the arrangement of the liquid crystal molecules in liquid crystal light valve 33 comes into the lag of phase of the light beam 62 and the corresponding variation of the polarization status. Finally, the corresponding Jones matrix of the polarization status of the light beam 62 passes through the analyzer module 63 is

$$( \begin{matrix}1 & 0 \\ 0 & 0\end{matrix} ) \cdot ( \begin{matrix}cos ( \frac{π}{4} ) & - i \cdot sin ( \frac{π}{4} ) \\ - i \cdot sin ( \frac{π}{4} ) & cos ( \frac{π}{4} )\end{matrix} ) \cdot ( \begin{matrix}{ⅇ}^{- ⅈ \frac{Γ}{2}} & 0 \\ 0 & {ⅇ}^{ⅈ \frac{Γ}{2}}\end{matrix} ) \cdot \frac{1}{\sqrt{2}} ( \begin{matrix}1 \\ - i\end{matrix} ) = - i \cdot sin ( \frac{Γ}{2} ) ( \begin{matrix}1 \\ 0\end{matrix} )$$

where the brightness of the light beam 62 is

$${sin}^{2} ( \frac{Γ}{2} )$$

which means different brightness can be obtained due to different phase lag Γ by changing the electric voltage.

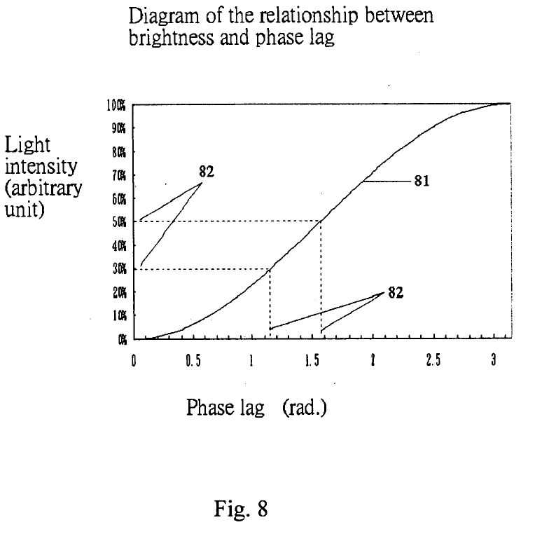

FIG. 8 illustrates the relationship between brightness and phase lag according to the apparatus in FIG. 7. The vertical coordinates represent the light intensity whose unit is arbitrary unit and is usually expressed by percent (%). The abscissa represents the phase lag Γ whose unit is radian (rad.) and different phase lag can be obtained by applying different electrical voltages. The curve 81 is the corresponding relationship between light intensity and phase lag. The dotted line 82 shows that different light intensity corresponds to the different phase lag.

There are usually a plural number of pixels arranged as an array on the LCD apparatus. The formation of images is to have different brightness on each pixel by applying specific electric voltages on the liquid crystal light valve of specific pixels. Different voltages are applied on the liquid crystal light valve of each pixel to have different brightness of light beam. There is a fringing-field effect which can cause distortion of the brightness of the light beam due to a horizontal electric field created along the fringe of neighboring pixels. The electric field produced due to the different voltages applied on the liquid crystal light valve of pixels affects the arrangement of the liquid crystal molecules, causes the phase lag of the light beam passing through the liquid crystal light valve and then distorts the brightness of the light beam. The More the deflection angle θ, the more the liquid crystal molecules are deviated from the ideal orientation. Considering the deflection angle θ due to fringing-field effect, the polarization status of the light beam 62 passing through the analyzer 63 is

$$( \begin{matrix}1 & 0 \\ 0 & 0\end{matrix} ) \cdot ( \begin{matrix}cos ( \frac{π}{4} ) & - i \cdot sin ( \frac{π}{4} ) \\ - i \cdot sin ( \frac{π}{4} ) & cos ( \frac{π}{4} )\end{matrix} ) \cdot {M}_{LC , T , FFE} \cdot \frac{1}{\sqrt{2}} ( \begin{matrix}1 \\ - i \end{matrix} ) = - i \cdot sin ( \frac{Γ}{2} ) ( cos ( 2 θ ) - i \cdot sin ( 2 θ ) ) ( \begin{matrix}1 \\ 0\end{matrix} )$$

where

$${M}_{LC , T , FFE} = ( \begin{matrix}cos θ & - sin θ \\ sin θ & cos θ\end{matrix} ) \cdot ( \begin{matrix}{ⅇ}^{- ⅈ \frac{Γ}{2}} & 0 \\ 0 & {ⅇ}^{ⅈ \frac{Γ}{2}}\end{matrix} ) \cdot ( \begin{matrix}cos θ & sin θ \\ - sin θ & cos θ\end{matrix} )$$

is the Jones matrix of the liquid crystal light valve 33 considering the effect of the deflection angle θ. The brightness corresponds to the light beam 62 is

$${sin}^{2} ( \frac{Γ}{2} ) .$$

The brightness of the light beam 62 in the optical system design in the present invention is the same as the brightness of the light beam in the prior art optical system without considering the fringing-field effect. The present invention solves the fringing-field effect which causes the deterioration of the brightness of the light beam. The horizontal electric field of the fringing-field effect deflects the liquid crystal molecules on the XY plane in the liquid crystal light valve 33. In the present invention, the horizontal electric field is insignificant by using the light beam with symmetric circular polarization status. By using the light beam with the circular polarization status, the fringing-field effect is kept away even there is any deflection angle on the liquid crystal molecules.

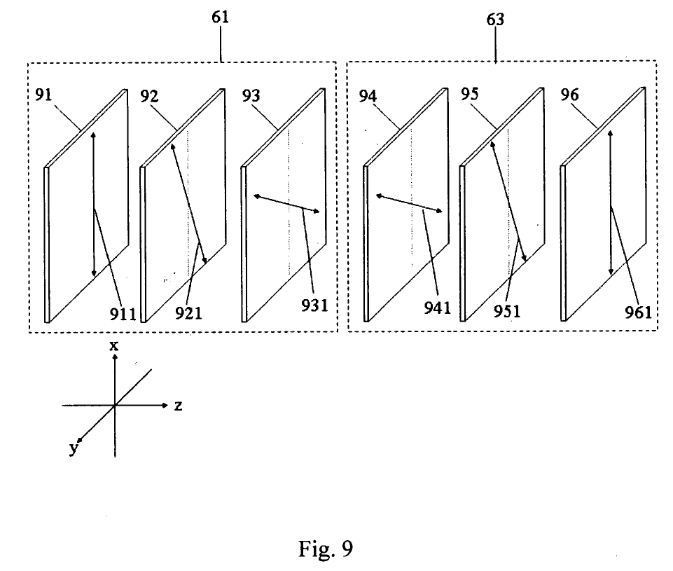

FIG. 9 is a dissection diagram illustrates another combination of the circular polarization module and the analyzer module in FIG. 6. The circular polarization module 61 comprising a linear polarization component 91 whose transparent axis 911 is parallel to X-axis, a half wave plate 92 and a quarter wave plate 93 has the corresponding Jones matrix

$$( \begin{matrix}1 & 0 \\ 0 & 0\end{matrix} ) .$$

The corresponding Jones matrix of the polarization status of the light beam 62 passing through the linear polarization component 91 is

$$( \begin{matrix}1 \\ 0\end{matrix} ) .$$

The included angle of the slow axis 921 of the half wave plate 92 and the transparent axis 911 of the linear polarization component 91 is 15° and the corresponding Jones matrix is

$${M}_{circle , \frac{1}{2}} = ( \begin{matrix}cos ( \frac{π}{12} ) & - sin ( \frac{π}{12} ) \\ sin ( \frac{π}{12} ) & cos ( \frac{π}{12} )\end{matrix} ) \cdot ( \begin{matrix}{ⅇ}^{- ⅈ \frac{π}{2}} & 0 \\ 0 & {ⅇ}^{ⅈ \frac{π}{2}}\end{matrix} ) \cdot ( \begin{matrix}cos ( \frac{π}{12} ) & sin ( \frac{π}{12} ) \\ - sin ( \frac{π}{12} ) & cos ( \frac{π}{12} )\end{matrix} ) .$$

The included angle of the slow axis 931 of the half wave plate 93 and the transparent axis 911 of the linear polarization component 91 is 75° and the corresponding Jones matrix is

$${M}_{circle , \frac{1}{4}} = ( \begin{matrix}cos ( \frac{5 π}{12} ) & - sin ( \frac{5 π}{12} ) \\ sin ( \frac{5 π}{12} ) & cos ( \frac{5 π}{12} )\end{matrix} ) \cdot ( \begin{matrix}{ⅇ}^{- ⅈ \frac{π}{4}} & 0 \\ 0 & {ⅇ}^{ⅈ \frac{π}{4}}\end{matrix} ) \cdot ( \begin{matrix}cos ( \frac{5 π}{12} ) & sin ( \frac{5 π}{12} ) \\ - sin ( \frac{5 π}{12} ) & cos ( \frac{5 π}{12} )\end{matrix} ) .$$

The Jones matrix of the polarization status of the light beam 62 passing the circular polarization module is

$${M}_{circle , \frac{1}{4}} \cdot {M}_{circle , \frac{1}{2}} \cdot ( \begin{matrix}1 \\ 0\end{matrix} ) = \frac{\sqrt{2} - i \sqrt{6}}{4} ( \begin{matrix}1 \\ - i\end{matrix} )$$

which is a circular polarization status, in particular, a counterclockwise circular polarization status. The analyzer polarization module 62 comprises a quarter wave plate 94, a half wave plate 95 and a linear polarization component 96. The orientation of the slow axis 941 of the quarter wave plate 94 is parallel to that of the slow axis 931 of the quarter wave plate 93 and the corresponding Jones matrix is

$${M}_{analyzer , \frac{1}{4}} = ( \begin{matrix}cos ( \frac{5 π}{12} ) & - sin ( \frac{5 π}{12} ) \\ sin ( \frac{5 π}{12} ) & cos ( \frac{5 π}{12} )\end{matrix} ) \cdot ( \begin{matrix}{ⅇ}^{- ⅈ \frac{π}{4}} & 0 \\ 0 & {ⅇ}^{ⅈ \frac{π}{4}}\end{matrix} ) \cdot ( \begin{matrix}cos ( \frac{5 π}{12} ) & sin ( \frac{5 π}{12} ) \\ - sin ( \frac{5 π}{12} ) & cos ( \frac{5 π}{12} )\end{matrix} ) .$$

The orientation of the slow axis 951 of the half wave plate 95 is parallel to that of the slow axis 921 of the quarter wave plate 92 and the corresponding Jones

$$is {M}_{analyzer , \frac{1}{2}} = ( \begin{matrix}cos ( \frac{π}{12} ) & - sin ( \frac{π}{12} ) \\ sin ( \frac{π}{12} ) & cos ( \frac{π}{12} )\end{matrix} ) \cdot ( \begin{matrix}{ⅇ}^{- ⅈ \frac{π}{4}} & 0 \\ 0 & {ⅇ}^{ⅈ \frac{π}{4}}\end{matrix} ) \cdot ( \begin{matrix}cos ( \frac{π}{12} ) & sin ( \frac{π}{12} ) \\ - sin ( \frac{π}{12} ) & cos ( \frac{π}{12} )\end{matrix} ) .$$

The orientation of the transparent axis 961 of the linear polarization component 96 is parallel to the that of the transparent axis 911 of the linear polarization component 91 and the corresponding Jones matrix is

$$( \begin{matrix}1 & 0 \\ 0 & 0\end{matrix} ) .$$

The Jones matrix of the liquid crystal light valve 33 is

$$( \begin{matrix}{ⅇ}^{- ⅈ \frac{Γ}{2}} & 0 \\ 0 & {ⅇ}^{ⅈ \frac{Γ}{2}}\end{matrix} )$$

where Γ represents the phase lag. The polarization status of the light beam 62 passing the analyzer module 63 is

$${M}_{analyzer , \frac{1}{2}} \cdot {M}_{analyzer , \frac{1}{4}} \cdot ( \begin{matrix}{ⅇ}^{- ⅈ \frac{Γ}{2}} & 0 \\ 0 & {ⅇ}^{ⅈ \frac{Γ}{2}}\end{matrix} ) \cdot \frac{\sqrt{2} - i \sqrt{6}}{4} ( \begin{matrix}1 \\ - ⅈ\end{matrix} ) = \frac{- \sqrt{3} + i}{2} sin ( \frac{Γ}{2} ) ( \begin{matrix}1 \\ 0\end{matrix} ) .$$

The brightness of the light beam 62 is

$${sin}^{2} ( \frac{Γ}{2} )$$

which means different brightness can be obtained with different phase lag Γ by applying specific electric voltages. Taking the effect from the deflection angle θ of the liquid crystal molecules due to the fringing-field effect into account, the corresponding Jones matrix of the polarization status of the light beam 62 passing through analyzer module 63 is

$${M}_{analyzer , \frac{1}{2}} \cdot {M}_{analyzer , \frac{1}{4}} \cdot {M}_{LC , T , FFE} \cdot \frac{\sqrt{2} - i \sqrt{6}}{4} ( \begin{matrix}1 \\ - i\end{matrix} ) = \frac{- \sqrt{3} + i}{2} sin ( \frac{Γ}{2} ) ( cos ( 2 θ ) - i sin ( 2 θ ) ) ( \begin{matrix}1 \\ 0\end{matrix} )$$

where

$${M}_{LC , T , FFE} = ( \begin{matrix}cos θ & - sin θ \\ sin θ & cos θ\end{matrix} ) \cdot ( \begin{matrix}{ⅇ}^{- ⅈ \frac{Γ}{2}} & 0 \\ 0 & {ⅇ}^{ⅈ \frac{Γ}{2}}\end{matrix} ) \cdot ( \begin{matrix}cos θ & sin θ \\ - sin θ & cos θ\end{matrix} )$$

is the Jones matrix of the liquid crystal light valve 33 including the deflection angle θ. The brightness of the light beam 62 in the present invention is

$${sin}^{2} ( \frac{Γ}{2} )$$

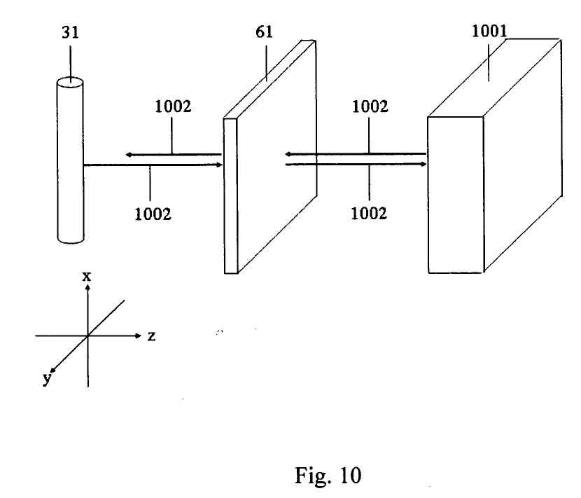

which is the same as the brightness in the prior art system not considering the fringing-field effect. It means the annoying fringing-field effect which causes the deteriorated brightness is avoided in the optical system design in the present invention. The circular polarization module in the FIG. 7 is usually a wideband circular polarization module. Only in theoretical situation, a light beam can have a fixed wavelength. In fact, a light beam usually has a set of wavelengths distributed in a small range. For example, the wavelength of a red light beam disperses around 650 nm±30 nm which means the inaccuracy of the wavelength is 60 nm. This inaccuracy makes a light beam with dispersible wavelengths to have an elliptic polarization status rather than a pure circular polarization status after passing a general circular polarization module. The light intensity in an optical system design is degenerated by this dispersible property. The inaccuracy is solved in the present invention in FIG. 9 by inserting a half wave plate 92 and a quarter wave plate 93 to compensate those errors resulted from the wavelength dispersible property of a light beam. This installation mentioned above can modulate a general light beam to have a circular polarization status. The circular polarization module can be implemented by a lot of combinations by optical devices arbitrarily. The embodiment mentioned in FIG. 9 is an illustration and not to limit the implementation of the present invention, i.e. a single circular polarization component can be used as a circular polarization module. FIG. 10 illustrates another optical system implemented based on the present invention. The optical system design comprises a light generation module 31, a circular polarization module 61 and a liquid crystal light valve 1001 The liquid crystal light valve 1001 can be a vertical alignment liquid crystal light valve. In this implementation, the liquid crystal light valve 1001 is a reflection type liquid crystal light valve so the optical system design in this example is called as reflection type liquid crystal light valve. The light generation module 31 is used to produce a light beam 1002. The circular polarization module 61 is used to modulate the polarization status of the light beam 1002 to become a circular polarization status. The light beam 1002 passing the liquid crystal light valve 1001 perpendicularly will be reflected along the incident path and passes the circular polarization module 61 again. The function of the circular polarization module 61 is the same as that of the analyzer module to determine the light intensity of the light beam 1002 when the light beam returns from the liquid crystal light valve. The corresponding Jones matrix of the liquid crystal light valve 1001 is

$${M}_{LC , R} = ( \begin{matrix}{ⅇ}^{- ⅈ \frac{Γ}{2}} & 0 \\ 0 & {ⅇ}^{ⅈ \frac{Γ}{2}}\end{matrix} ) \cdot ( \begin{matrix}1 & 0 \\ 0 & - 1\end{matrix} ) \cdot ( \begin{matrix}{ⅇ}^{- ⅈ \frac{Γ}{2}} & 0 \\ 0 & {ⅇ}^{ⅈ \frac{Γ}{2}}\end{matrix} )$$

where the Γ represents the phase lag and

$$( \begin{matrix}1 & 0 \\ 0 & - 1\end{matrix} )$$

means the light beam 1002 has a reversed phase shift after reflected from the liquid crystal light valve. Including the effect of the deflection angle θ due to the fringing-field effect, the Jones matrix can be written as

$${M}_{LC , R , FFE} = ( \begin{matrix}cos θ & sin θ \\ - sin θ & cos θ\end{matrix} ) ( \begin{matrix}{ⅇ}^{- ⅈ \frac{r}{2}} & 0 \\ 0 & {ⅇ}^{ⅈ \frac{r}{2}}\end{matrix} ) ( \begin{matrix}cos θ & - sin θ \\ sin θ & cos θ\end{matrix} ) \cdot ( \begin{matrix}1 & 0 \\ 0 & - 1\end{matrix} ) \cdot ( \begin{matrix}cos θ & - sin θ \\ sin θ & cos θ\end{matrix} ) ( \begin{matrix}{ⅇ}^{- ⅈ \frac{r}{2}} & 0 \\ 0 & {ⅇ}^{ⅈ \frac{r}{2}}\end{matrix} ) \cdot ( \begin{matrix}cos θ & sin θ \\ - sin θ & cos θ\end{matrix} )$$

If the circular polarization module 61 is designed as that in the design in FIG. 7, the polarization status of the light beam 1002 after passing through the circular polarization module 61 is a circular polarization status, in particular, a counterclockwise circular polarization status whose Jones matrix is

$$\frac{1}{\sqrt{2}} ( \begin{matrix}1 \\ - i\end{matrix} ) .$$

The Jones matrix of the circular polarization module 61 is

$$( \begin{matrix}1 & 0 \\ 0 & 0\end{matrix} ) \cdot ( \begin{matrix}cos ( \frac{π}{4} ) & i \cdot sin ( \frac{π}{4} ) \\ i \cdot sin ( \frac{π}{4} ) & cos ( \frac{π}{4} )\end{matrix} )$$

for the light beam 1002 reflected from the liquid crystal light valve 1001. After reflected from the liquid crystal light valve 1001 and passing through the circular polarization module 61 again, the Jones matrix of the light beam 1002 is

$$( \begin{matrix}1 & 0 \\ 0 & 0\end{matrix} ) \cdot ( \begin{matrix}cos ( \frac{π}{4} ) & i \cdot sin ( \frac{π}{4} ) \\ i \cdot sin ( \frac{π}{4} ) & cos ( \frac{π}{4} )\end{matrix} ) \cdot {M}_{LC , R} \cdot \frac{1}{\sqrt{2}} ( \begin{matrix}1 \\ - i\end{matrix} ) = - i \cdot sin ( Γ ) ( \begin{matrix}1 \\ 0\end{matrix} ) .$$

The brightness of the light beam 1002 is sin²(Γ). Including the effect of the deflection angle θ due to the fringing-field effect, the Jones matrix of the reflected light beam 1002 passing through the circular polarization module 61
can be written as

$$( \begin{matrix}1 & 0 \\ 0 & 0\end{matrix} ) \cdot ( \begin{matrix}cos ( \frac{π}{4} ) & i \cdot sin ( \frac{π}{4} ) \\ i \cdot sin ( \frac{π}{4} ) & cos ( \frac{π}{4} )\end{matrix} ) \cdot {M}_{LC , R , FFE} \cdot \frac{1}{\sqrt{2}} ( \begin{matrix}1 \\ - i\end{matrix} ) = - i \cdot sin ( Γ ) ( cos ( 2 θ ) - i \cdot sin ( 2 θ ) ) ( \begin{matrix}1 \\ 0\end{matrix} ) .$$

The brightness of the light beam 1002 is sin²(Γ) which is the same as the brightness of the prior art system calculated without considering the fringing-field effect. It means the optical system design in the present invention can avoid the deterioration of the brightness due to the fringing-field effect.
If the circular polarization module 61 is designed as that in the design in FIG. 9, the polarization status of the light beam 1002 after passing through the circular polarization module 61 is a circular polarization status, in particular, a counterclockwise circular polarization status whose Jones matrix is

$$\frac{\sqrt{2} - i \sqrt{6}}{4} ( \begin{matrix}1 \\ - i\end{matrix} ) .$$

When the reflected light beam passes the circular polarization module 61, the corresponding Jones matrixes of the quarter wave plate 93, half wave plate 92 and linear polarization component 91 are

$${M}_{circle , \frac{1}{4} , R} = ( \begin{matrix}cos ( \frac{5 π}{12} ) & sin ( \frac{5 π}{12} ) \\ - sin ( \frac{5 π}{12} ) & cos ( \frac{5 π}{12} )\end{matrix} ) \cdot ( \begin{matrix}{ⅇ}^{- ⅈ \frac{π}{4}} & 0 \\ 0 & {ⅇ}^{ⅈ \frac{π}{4}}\end{matrix} ) \cdot ( \begin{matrix}cos ( \frac{5 π}{12} ) & - sin ( \frac{5 π}{12} ) \\ sin ( \frac{5 π}{12} ) & cos ( \frac{5 π}{12} )\end{matrix} ) , \\ {M}_{circle , \frac{1}{2} , R} = ( \begin{matrix}cos ( \frac{π}{12} ) & sin ( \frac{π}{12} ) \\ - sin ( \frac{π}{12} ) & cos ( \frac{π}{12} )\end{matrix} ) \cdot ( \begin{matrix}{ⅇ}^{- ⅈ \frac{π}{2}} & 0 \\ 0 & {ⅇ}^{ⅈ \frac{π}{2}}\end{matrix} ) \cdot ( \begin{matrix}cos ( \frac{π}{12} ) & - sin ( \frac{π}{12} ) \\ sin ( \frac{π}{12} ) & cos ( \frac{π}{12} )\end{matrix} ) , \\ and \\ {M}_{circle , LP , R} = ( \begin{matrix}1 & 0 \\ 0 & 0\end{matrix} )$$

respectively. The Jones matrix of the reflected light beam 1002 passing through circular polarization module 61 is

$${M}_{circle , LP , R} \cdot {M}_{circle , \frac{1}{2} , R} \cdot {M}_{circle , \frac{1}{4} , R} \cdot {M}_{LC , R} \cdot \frac{\sqrt{2} - i \sqrt{6}}{4} ( \begin{matrix}1 \\ - i\end{matrix} ) = - \frac{1}{2} ( \sqrt{3 } - i ) \cdot sin ( Γ ) ( \begin{matrix}1 \\ 0\end{matrix} ) .$$

The brightness of the light beam 1002 is sin²(Γ). Including the effect of the deflection angle θ due to the fringing-field effect, the Jones matrix of the reflected light beam 1002 passing through the circular polarization module 61 can be written as

$${M}_{circle , LP , R} \cdot {M}_{circle , \frac{1}{2} , R} \cdot {M}_{circle , \frac{1}{4} , R} \cdot {M}_{LC , R , FFE} \cdot \frac{\sqrt{2} - i \sqrt{6}}{4} ( \begin{matrix}1 \\ - i\end{matrix} ) = - \frac{( \sqrt{3} - i )}{2} \cdot sin ( Γ ) \cdot ( cos ( 2 θ ) - i \cdot sin ( 2 θ ) ) ( \begin{matrix}1 \\ 0\end{matrix} )$$

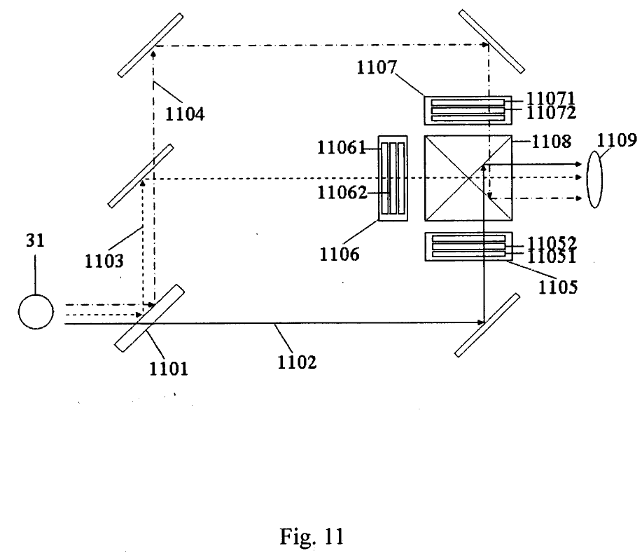

. The brightness of the light beam 1002 is sin²(Γ) which is the same as the brightness of the prior art system calculated without considering the fringing-field effect. It means that the optical system design in the present invention can avoid the deterioration of the brightness due to the fringing-field effect.
FIG. 11 illustrates an application diagram of an optical system design according to the present invention. In the embodiment in FIG. 11, an optical path design of a transparent LCD apparatus is introduced. The light generation module 31 is used to produce a light beam. The light beam is separated by a spectroscope 1011 into three primary colors. The colors of the first light beam with primary color 1012, the second light beam with primary color 1013 and the third light beam with primary color 1014 are red, green and blue (RGB) which is the fundamental colors to form any combinations of colors in nature. These three light beams with primary colors pass through the light valve modules 1015, 1016 and 1017 respectively. The light valve modules comprise, based on the previous disclosed embodiments, circular polarization modules 10151, 10161, 10171 and liquid crystal light valves 10152, 10162, 10172 which are used to modulate the light intensity of the first light beam with primary color 1012, the second light beam with primary color 1013 and the third light beam with primary color 1014, respectively. The light beams pass through the three light valves 1015, 1016 and 1017. The three lights are merged by the X-cube 1018 and then the processing to display the image is accomplished. In particular, a projection lens 1019 can be included into this system to display the images and to form a projection LCD apparatus.
According to the embodiments mentioned above, the present invention provides an optical system design by using the circular polarization module to modulate the polarization status of the light beam to be in a circular polarization status so as to solve the problems caused by the fringing-field effect. The display quality of the LCD apparatus is improved obviously by performing the designs presented in the present invention. Although shown and described is what is believed to be the most practical and preferred embodiments, it is apparent that departures from specific designs and methods described and shown will suggest themselves to those skilled in the art and may be used without departing from the spirit and scope of the invention. The present invention is not restricted to the particular constructions described and illustrated, but should be construed to cohere with all modifications that may fall within the scope of the appended claims.

What is claimed is:

1. An optical system design, intended to be applied in a liquid crystal display (LCD) apparatus, comprising:
a light generation module, generating a light beam;
at least one circular polarization module, modulating said light beam in order to have a light beam with a circular polarization status; and
a liquid crystal light valve, modulating the polarization status of said light beam.

2. The optical system design according to claim 1, wherein said circular polarization module further comprises at least one linear polarization component and a quarter wave plate.

3. The optical system design according to claim 2, the slow axis of said quarter wave plate and the transparent axis of said linear polarization component toward each other at an included angle of 45 degree.

4. The optical system design according to claim 1, wherein said circular polarization module further comprises at least one linear polarization component, a quarter wave plate and a half wave plate.

5. The optical system design according to claim 4, wherein the slow axis of said half wave plate and the transparent axis of said linear polarization component toward each other at an included angle of 15 degree and the slow axis of said quarter wave plate and the transparent axis of said linear polarization component toward each other at an included angle of 75 degree.

6. The optical system design according to claim 1, wherein said circular polarization module further comprises at least one circular polarization component.

7. The optical system design according to claim 1, wherein said circular polarization module is a wideband circular polarization module.

8. The optical system design according to claim 1, wherein said LCD apparatus is a projection type LCD apparatus.

9. The optical system design according to claim 1, wherein said LCD apparatus is an active array LCD apparatus.

10. The optical system design according to claim 1, wherein said light generation module is a projection light source module.

11. The optical system design according to claim 1, wherein said light generation module is a back-lighted module.

12. The optical system design according to claim 1, wherein said liquid crystal light valve is a transparent liquid crystal light valve.

13. The optical system design according to claim 1, wherein said liquid crystal light valve is a reflection type transparent liquid crystal light valve.

14. The optical system design according to claim 1, wherein said liquid crystal light valve further comprises a negative type liquid crystal.

15. The optical system design according to claim 14, wherein said negative type liquid crystal is vertically aligned.
